(19) United States
(12) Patent Application Publication
(10) Pub. No.: US 2026/0153426 A1
(43) Pub. Date: Jun. 4, 2026

(54) METHOD FOR DETERMINING FEASIBILITY OF WATER-PRESERVING MINING WITH IN-SITU PROTECTION OF FLOOR CONFINED WATER

(71) Applicants: China University of Mining and Technology, Xuzhou City (CN); Yunlong Lake Laboratory of Deep Underground Science and Engineering, Xuzhou City (CN)

(72) Inventors: Gangwei FAN, Xuzhou City (CN); Zhanglei Fan, Xuzhou City (CN); Tao Luo, Xuzhou City (CN); Zihan Kong, Xuzhou City (CN); Dongsheng Zhang, Xuzhou City (CN); Xuesen Han, Xuzhou City (CN); Xin Yue, Xuzhou City (CN); Shizhong Zhang, Xuzhou City (CN)

(21) Appl. No.: 19/403,901

(22) Filed: Nov. 30, 2025

Related U.S. Application Data
(63) Continuation of application No. PCT/CN2025/113466, filed on Aug. 8, 2025.

(30) Foreign Application Priority Data
Dec. 3, 2024 (CN) 202411757592.1

(51) Int. Cl. G01N 15/08

(52) U.S. Cl. CPC G01N 15/0826

(57) ABSTRACT

A determination method for water-preserving mining with in-situ protection of floor confined water, including following steps: determining an average distance between a mining coal seam floor and an aquifer, an average thickness of the aquifer, an average permeability, a working face length, and an advance distance length; testing an average depth of a mining coal seam floor fracture zone, an average thickness of each rock layer below the fracture zone, and an average permeability to obtain an equivalent permeability; testing and statistically analyzing water pressure of the confined aquifer to determine a target water pressure; calculating an allowable water resource loss during coal mining; determining a critical equivalent permeability coefficient; comparing the equivalent permeability with the critical equivalent permeability coefficient and comparing a calculated water inflow with a safe water inflow for working face mining; determining feasibility of water-preserving mining with in-situ protection of floor confined water.

### CROSS-REFERENCE TO RELATED APPLICATIONS

This application is a continuation of International Patent Application No. PCT/CN2025/113466, filed on Aug. 8, 2025, and claims priority of Chinese Patent Application No. 202411757592.1, filed on Dec. 3, 2024. The contents of International Patent Application No. PCT/CN2025/113466 and Chinese Patent Application No. 202411757592.1 are hereby incorporated by reference.

### TECHNICAL FIELD

The present disclosure relates to the technical field of water-preserving mining, and particularly to a determination method for water-preserving mining with in-situ protection of floor confined water.

### BACKGROUND

Water-preserving mining has long been a hotspot in academic research, with its concepts and technologies becoming increasingly refined and mature. For in-situ protection of floor water, preliminary technical methods have been developed, using evaluation indicators such as the height of water-conducting fracture zones, stability of key water-resisting layers, or water-resisting layer groups. Chinese scholars have achieved abundant research results in the prevention and control of floor confined water inrushes. By analyzing characteristics of mining-induced floor deformation and failure, as well as fracture development depth, theories and evaluation methods for floor water inrushes have been proposed, effectively guiding safe mine production. Examples include the “vulnerability index method,” the “five-map dual-coefficient method,” and the “water inrush coefficient method.” Scholars have shifted focus from “hazard prevention of floor confined water” to “in-situ water-preserving mining of floor confined water.” However, existing research has the following shortcomings.

Current studies pay little attention to in-situ protection of floor water, focusing instead on safe mining and proposing corresponding resistance-enhancing technical parameters and early warning technologies. There is a need to integrate water-preserving mining and safe mining, leveraging the complementary relationship between the two approaches. Further, most studies remain limited to theoretical evaluation, without integration of measurement systems, drilling layouts, or automatic control hardware into the determination process.

Existing methods, such as stability evaluation of key water-resisting layers and the water inrush coefficient method, may provide some reference for in-situ protection of floor water. However, the methods do not account for differences and heterogeneity in rock layer hydromechanical properties. A quantitative analysis of the overall water-blocking performance of effective water-resisting layers may be conducted to directly provide a determination method for water-preserving mining with in-situ protection of floor confined water. In particular, existing methods are often limited to mathematical calculations without coupling to non-conventional drilling data collection or mine control systems, which reduces their technical applicability in the field.

It is necessary to focus not only on the stability of the confined aquifer within the mining range but also to ensure the stability of the confined aquifer outside the mining-affected range. This means avoiding disruption of recharge through the confined aquifer within the mining range, preventing scenarios where the confined aquifer outside the affected area only experiences discharge without recharge. The conventional critical condition, where the recharge volume of the aquifer within the mining range equals the water leakage volume of the working face, may not be applied. Furthermore, since confined aquifers are generally thick with ample recharge, excessive water leakage at the working face would severely impact safe mining. Therefore, in-situ protection of floor water requires special considerations. Accordingly, there is a need for a determination method that incorporates heterogeneous rock layer testing, adaptive drilling, and integration with mine operation hardware to achieve both safe mining and in-situ aquifer protection.

Chinese Patent No. CN110749533B, titled A Determination Method for Water-Preserving Coal Mining Based on Equivalent Water-Resisting Layer Thickness, discloses a method including: determining thicknesses Mᵢ of overlying rock layers and total overburden thickness M; testing permeability coefficients Kᵢ of post-mining overlying rock layers; calculating an equivalent permeability coefficient Kᵥ of the overburden; determining water table depth H₀ and recharge volume V_{recharge} of the aquifer; determining post-mining water head height of the aquifer; calculating a critical equivalent water-resisting layer thickness M_{equiv} for achieving water-preserving coal mining; and comparing the critical equivalent water-resisting layer thickness M_{equiv} with the total thickness M of all rock layers from the coal seam roof to the water-resisting layer to determine feasibility of water-preserving coal mining. This method, based on changes in overall permeability coefficients and leakage volume characteristics of the overburden before and after mining, provides a direct determination method for feasibility of water-preserving coal mining in protecting roof aquifers, based on the intrinsic aquiclude properties of rock layers, offering greater accuracy, efficiency, and field applicability. However, this method does not consider the influence of fracture zones, which minimally affect the water-blocking performance of rock layers but reduce the hydraulic gradient from the aquifer to the working face, leading to an increased critical equivalent water-resisting thickness. The method also ignores differences and heterogeneity in rock layer hydromechanical properties, as permeability coefficients vary due to differences in water-rock interactions and stress states at different locations of the floor. Additionally, the method does not account for stability of the aquifer outside the mining-affected range, merely assuming a boundary condition where infiltration volume equals recharge volume. Consequently, aquifers downstream of the mining-affected range would lack recharge. Moreover, if the aquifer recharge volume is large, complete infiltration would jeopardize safe mining at the working face. Therefore, the present invention provides a method that integrates data acquisition, determination, and automatic control of mining equipment, enabling non-conventional drilling layouts, fracture zone characterization, and real-time operational adjustments to achieve both safe mining and in-situ protection of floor confined water.

### SUMMARY

To address the aforementioned shortcomings in prior art, such as neglecting differences and heterogeneity in rock layer hydromechanical properties, ignoring aquifer stability, and assuming boundary conditions where aquifer infiltration volume equals recharge volume, which may compromise safe mining at the working face, the present disclosure proposes a determination method for water-preserving mining with in-situ protection of floor confined water. This method fully considers differences and heterogeneity in rock layer hydromechanical properties, balances water-preserving mining and safe mining, and provides a simple, highly operable, and field-applicable determination method.

The technical scheme of the present disclosure includes the following steps:
S1, determining an average distance M between a mining coal seam floor and an aquifer, an average thickness M_{aqu} of the aquifer, an average permeability K_{aqu} of the aquifer, a working face length L_{face}, and an advance distance length L_{adv};
S2, detecting to obtain an average depth M_{frac} of a mining coal seam floor fracture zone, an average thickness Mᵢ of each rock layer below the fracture zone, an average permeability Kᵢ of each rock layer below the fracture zone, and an equivalent permeability K_{eq} of a layered heterogeneous floor;
S3, detecting and calculating a total time as tₜₒₜₐₗ, a water pressure Pᵢ in different time periods within a confined aquifer, and determining a target water pressure P_{target} of a target confined aquifer; comparing the detected water pressure Pᵢ of the confined aquifer with the target water pressure P_{target}, and obtaining a water pressure P_{excess} of the confined aquifer exceeding the target water pressure P_{target} and a time t, where the water pressure Pᵢ of the confined aquifer exceeds the target water pressure P_{target};
S4, substituting the target water pressure P_{target}, the water pressure P_{excess}, and the time t obtained in the step S3 into a formula

$${S}_{allow} = \frac{{K}_{aqu}}{μ} \times ∇ {\int }_{0}^{t} ( {P}_{excess} - {P}_{target} ) \times {L}_{face} \times {M}_{aqu} dt ,$$

to obtain an allowable water resource loss S_{allow} during coal mining; where μ is a hydrodynamic viscosity coefficient in Pascal-second (Pa·s);
S5, substituting the water pressure Pᵢ of the confined aquifer obtained in the step S3 and the allowable water resource loss S_{allow} obtained in the step S4 into a formula

$${K}_{c r itical} = {S}_{allow} \times μ \div ( {L}_{adv} \times {L}_{face} \times {\int }_{0}^{{t}_{total}} ( ( {P}_{i} - {P}_{work} ) \div ( M - {M}_{frac} ) ) dt ) ,$$

to obtain a critical equivalent permeability coefficient K_{critical} of water-resisting rock layers in the mining coal seam floor; where tₜₒₜₐₗ is a total detection time in days; K_{critical} is the critical equivalent permeability coefficient of the water-resisting rock layers in the mining coal seam floor in Darcy (D); and P_{work} is a working face water pressure in Megapascal (MPa); and

S6, determining feasibility of the water-preserving mining with the in-situ protection of the floor confined water;

S61, comparing the equivalent permeability K_{eq} of the layered heterogeneous floor obtained in the step S2 with the critical equivalent permeability coefficient K_{critical} of the water-resisting rock layers in the mining coal seam floor obtained in the step S5, where if K_{eq}>K_{critical}, the in-situ protection of the floor confined water may not be achieved after the coal mining; and if K_{eq}≤K_{critical}, the step S62 is executed; and

S62, substituting the equivalent permeability K_{eq} of the layered heterogeneous floor, the average depth M_{frac} of the mining coal seam floor fracture zone, the average distance M between the mining coal seam floor and the aquifer, the working face length L_{face}, the advance distance length L_{adv}, and the water pressure Pᵢ of the confined aquifer into a formula Q_{inflow}=K_{eq}÷μ×(Pᵢ−P_{work})÷(M−M_{frac})×L_{adv}×L_{face}, to obtain a unit-time water inflow Q_{inflow} over the total time; where if no continuous period exists with Q_{inflow}≥Q_{safe} lasting more than 5 days, the in-situ protection of the floor confined water may be achieved; and if there is the continuous period with Q_{inflow}≥Q_{safe} lasting more than 5 days, the in-situ protection of the floor confined water may not be achieved, where Q_{safe} is a safe water inflow for working face mining in cubic meters per day (m³/day), wherein the feasibility determination is used to adjust a coal mining operation plan to ensure in-situ protection of confined water.

In this embodiment, the step S2 includes the following steps:
S21, arranging A×B drilling measurement points within a mining range composed of the working face length L_{face} and the advance distance length L_{adv}, and obtaining a plurality of depths of the floor fracture zone, thicknesses of rock layers below the fracture zone, and permeabilities;
S22, averaging the plurality of depths of the floor fracture zone, thicknesses of the rock layers, and permeabilities detected in the step S21, obtaining the average depth M_{frac} of the mining coal seam floor fracture zone, the average thickness Mᵢ of each rock layer below the fracture zone, and the average permeability Kᵢ of each rock layer below the fracture zone;
S23, substituting the average depth M_{frac} of the mining coal seam floor fracture zone, the average thickness Mᵢ of each rock layer below the fracture zone, and the average permeability Kᵢ of each rock layer below the fracture zone obtained in the step S22 into a formula

$${K}_{e q} = ( M - {M}_{frac} ) \div {\sum }_{1}^{n} \frac{{M}_{i}}{{K}_{i}} ,$$

to obtain the equivalent permeability K_{eq} of the layered heterogeneous floor; and where i=1, 2, 3, . . . , n, and n is the number of the rock layers below the fracture zone.

In this embodiment, in the step S1, the average distance M between the mining coal seam floor and the aquifer, the average thickness M_{aqu} of the aquifer, the average permeability K_{aqu} of the aquifer, the working face length L_{face}, and the advance distance length L_{adv} are obtained through on-site drilling and by reviewing mine geological and hydrogeological exploration reports and mine development plans.

In this embodiment, in the step S2, the depth of the floor fracture zone is primarily detected through on-site water pressure testing, supplemented by a parallel electrical method, the thickness of each rock layer below the fracture zone is obtained through the on-site drilling, the plurality of thicknesses of the rock layers below the fracture zone are averaged to obtain the average thickness Mᵢ of each rock layer below the fracture zone, and the average permeability Kᵢ of each rock layer below the fracture zone is obtained through water pressure testing during drilling, followed by data averaging.

In this embodiment, in the step S21, the A and the B are set to 10 and 5 respectively, and measurement point spacings along working face strike and dip directions are L_{adv}/9 and L_{face}/4 respectively.

In this embodiment, in the step S3, the total detection time tₜₒₜₐₗ takes one year as one cycle, and the different time periods are divided into four quarters.

In this embodiment, in the step S3, the target water pressure P_{target} is determined by calculating an average confined water pressure in spring and autumn and taking a maximum value as the target water pressure P_{target}.

In this embodiment, in the step S4, the water pressure P_{excess} of the confined aquifer exceeding the target water pressure P_{target} and the time/are statistically analyzed during summer and winter states of the confined aquifer.

In this embodiment, in the step S5, when the critical equivalent permeability coefficient K_{critical} of the water-resisting rock layers in the mining coal seam floor is calculated, the allowable water resource loss S_{allow} is averaged over each day of the year; and the working face water pressure P_{work} is obtained through on-site testing.

In this embodiment, in the step S62, Q_{safe} is set to 1000 m³/day.

Compared with the prior art, the beneficial effects of the present disclosure are as follows.

The determination method provided by the present disclosure not only focuses on the stability of the aquifer within the mining range but also ensures the stability of the aquifer outside the mining-affected range. Specifically, it prevents disruption to groundwater recharge through aquifers within the mining range, eliminating scenarios where aquifers outside the affected area experience only discharge without recharge, thereby yielding more accurate conclusions.

Based on dynamic water storage-release characteristics of the confined aquifer and the overall water-blocking performance of effective water-resisting rock layers in the mining-induced floor, the present disclosure provides a simple and field-applicable determination method for water-preserving mining with in-situ protection of floor confined water.

### BRIEF DESCRIPTION OF THE DRAWINGS

FIG. 1 is an overall flowchart of the determination method of the present disclosure.

FIG. 2 is a schematic diagram of post-mining floor water-resisting rock layer structure failure and measurement point arrangement.

FIG. 3 is a point-line graph of water pressure Pᵢ of the confined aquifer and target water pressure P_{target} in different time periods in the embodiment.

FIG. 4 is a point-line graph of unit-time water inflow Q_{inflow} over the total time range in the embodiment.

### DETAILED DESCRIPTION OF THE EMBODIMENT

The advantages and features of the present disclosure will be illustrated and explained by the following non-limiting description of the optional embodiment, which is given by way of example only with reference to the attached drawings.

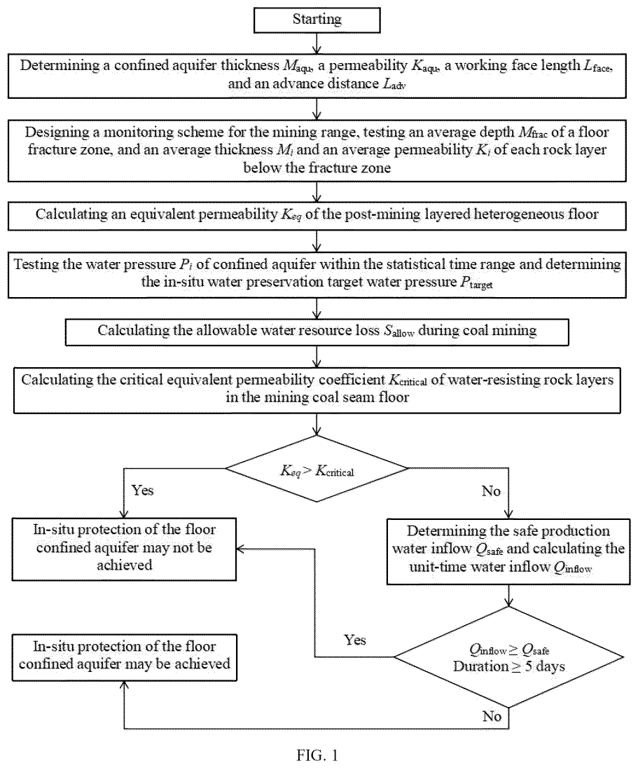

As shown in FIG. 1, the present disclosure provides a determination method for water-preserving mining with in-situ protection of floor confined water, including the following specific steps:
step S1, through on-site drilling and by reviewing mine geological and hydrogeological exploration reports and mine development plans, obtaining the average distance M between a mining coal seam floor and an aquifer, the average thickness M_{aqu} of the aquifer, the average permeability K_{aqu} of the aquifer, the working face length L_{face}, and the advance distance length L_{adv};
step S2, detecting to obtain an average depth M_{frac} of a mining coal seam floor fracture zone, an average thickness Mᵢ of each rock layer below the fracture zone, an average permeability Kᵢ of each rock layer below the fracture zone, and an equivalent permeability K_{eq} of a layered heterogeneous floor;
step S21, arranging A×B drilling measurement points within a mining range composed of the working face length L_{face} and the advance distance length L_{adv}, and obtaining a plurality of depths of the floor fracture zone, thicknesses of rock layers below the fracture zone, and permeabilities;
step S22, averaging the plurality of depths of the floor fracture zone, thicknesses of the rock layers, and permeabilities detected in the step S21, obtaining the average depth M_{frac} of the mining coal seam floor fracture zone, the average thickness Mᵢ of each rock layer below the fracture zone, and the average permeability Kᵢ of each rock layer below the fracture zone;
step S23, substituting the average depth M_{frac} of the mining coal seam floor fracture zone, the average thickness Mᵢ of each rock layer below the fracture zone, and the average permeability Kᵢ of each rock layer below the fracture zone obtained in the step S22 into a formula

$${K}_{e q} = ( M - {M}_{frac} ) \div {\sum }_{1}^{n} \frac{{M}_{i}}{{K}_{i}} ,$$

to obtain the equivalent permeability K_{eq} of the layered heterogeneous floor; and
where M is the average distance between the mining coal seam floor and the aquifer in meters (m); M_{frac} is the average depth of the mining coal seam floor fracture zone in m; Mᵢ is the average thickness of each rock layer below the fracture zone in m; Kᵢ is the average permeability of each rock layer below the fracture zone in Darcy (D); and i=1, 2, 3, . . . , n, and n is the number of the rock layers below the fracture zone.

Optionally, the depth of the floor fracture zone is detected primarily through on-site water pressure testing, supplemented by parallel electrical methods to ensure reasonable detection results. The thickness of each rock layer below the fracture zone is obtained through the on-site drilling, the plurality of thicknesses of the rock layers below the fracture zone are averaged to obtain the average thickness Mᵢ of each rock layer below the fracture zone, and the average permeability Kᵢ of each rock layer below the fracture zone is obtained through water pressure testing during drilling, followed by data averaging.

Optionally, within the mining range composed of the working face length L_{face} and the advance distance length L_{adv}, A×B drilling measurement points are arranged, where the A and the B are set to 10 and 5 respectively, and measurement point spacings along working face strike and dip directions are L_{adv}/9 and L_{face}/4 respectively.

Step S3, a total time is detected and calculated as tₜₒₜₐₗ, a water pressure Pᵢ is measured in different time periods within a confined aquifer, and a target water pressure P_{target} is determined for a target confined aquifer. The detected water pressure Pᵢ of the confined aquifer is compared with the target water pressure P_{target}, and the water pressure P_{excess} of the confined aquifer exceeding the target water pressure P_{target} and the time t during which the water pressure Pᵢ of the confined aquifer exceeds the target water pressure P_{target} are obtained. The target of the target confined aquifer is to achieve in-situ water preservation.

Optionally, the total detection time tₜₒₜₐₗ takes one year as one cycle, and the different time periods are divided into four quarters. The target water pressure P_{target} of the target confined aquifer is determined as follows: given the relatively stable water pressure in confined aquifer observed during spring and autumn, an average confined water pressure in spring and autumn is calculated, and a maximum value is taken as the target water pressure P_{target}.

Step S4, the target water pressure P_{target}, the water pressure P_{excess}, and the time t obtained in the step S3 are substituted into a formula

$${S}_{allow} = \frac{{K}_{a q u}}{μ} \times ∇ {\int }_{0}^{t} ( {P}_{excess} - {P}_{target} ) \times {L}_{face} \times {M}_{aqu} dt ,$$

to obtain an allowable water resource loss S_{allow} during coal mining.

In the formula, P_{target} is the target water pressure of the target confined aquifer in Megapascal (MPa); P_{excess} is the water pressure of the confined aquifer exceeding the target water pressure in MPa; t is the time during which the water pressure of the confined aquifer exceeds the target water pressure P_{target} in days; S_{allow} is the allowable water resource loss during coal mining in cubic meters (m³); and μ is the hydrodynamic viscosity coefficient in Pascal-second (Pa·s).

Optionally, the water pressure P_{excess} of the confined aquifer exceeding the target water pressure and the time/are statistically analyzed during summer and winter states of the confined aquifer.

Step S5, the water pressure Pᵢ of the confined aquifer obtained in the step S3 and the allowable water resource loss S_{allow} obtained in the step S4 are substituted into a formula

$${K}_{c r itical} = {S}_{allow} \times μ \div ( {L}_{adv} \times {L}_{face} \times {\int }_{0}^{{t}_{total}} ( ( {P}_{i} - {P}_{work} ) \div ( M - {M}_{frac} ) ) dt )$$

to obtain the critical equivalent permeability coefficient K_{critical} of the water-resisting rock layers in the mining coal seam floor for achieving in-situ protection of floor confined water, i.e., the total water resource loss equals the allowable water resource loss during coal mining.

In the formula, L_{adv} is the advance distance length of the working face in m; tₜₒₜₐₗ is the total detection time in days; Pᵢ is the water pressure of the confined aquifer in MPa; K_{critical} is the critical equivalent permeability coefficient of the water-resisting rock layers in the mining coal seam floor in D; and P_{work} is a working face water pressure in MPa.

When the critical equivalent permeability coefficient K_{critical} of the water-resisting rock layers in the mining coal seam floor is calculated, the allowable water resource loss S_{allow} is averaged over each day of the year. The confined water flowing to the working face is free water, and the working face water pressure P_{work} is set to 0 MPa.

Step S6, the feasibility of water-preserving mining with in-situ protection of floor confined water is determined.

Step S61, the equivalent permeability K_{eq} of the layered heterogeneous floor obtained in the step S2 is compared with the critical equivalent permeability coefficient K_{critical} of the water-resisting rock layers in the mining coal seam floor obtained in the step S5. If K_{eq}>K_{critical}, in-situ protection of floor confined water may not be achieved after coal mining. If K_{eq}≤K_{critical}, further judgment is required to determine whether in-situ protection of floor confined water may be achieved after coal seam mining, and step S62 is executed.

Step S62, if K_{eq}≤K_{critical}, the equivalent permeability K_{eq} of the layered heterogeneous floor, the average depth M_{frac} of the mining coal seam floor fracture zone, the average distance M between the mining coal seam floor and the aquifer, the working face length L_{face}, the advance distance length L_{adv}, and the water pressure Pᵢ of the confined aquifer are substituted into the formula Q_{inflow}=K_{eq}÷μ×(Pᵢ−P_{work})÷(M−M_{frac})×L_{adv}×L_{face}, to obtain a unit-time water inflow Q_{inflow} over the total time. To ensure safe mining at the working face, if no continuous period exists with Q_{inflow}≥Q_{safe} lasting more than 5 days, the in-situ protection of the floor confined water may be achieved; and if there is the continuous period with Q_{inflow}≥Q_{safe} lasting more than 5 days, the in-situ protection of the floor confined water may not be achieved, and in such case, the determination result is used to configure adjustments to mining operations, including at least one of: (i) reducing the advancement speed of the coal cutting machine, (ii) increasing the pumping rate of the dewatering pump, or (iii) initiating grout injection into the floor strata to reduce permeability, thereby mitigating water inflow and maintaining floor aquifer stability. The determination result is applied when the unit-time water inflow Q_{inflow} exceeds the safe threshold Q_{safe} for more than 5 days.

In the formula, Q_{inflow} is the unit-time water inflow in cubic meters per day (m³/day); and Q_{safe} is a safe water inflow for working face mining in m³/day. Optionally, Q_{safe} is set to 1000 m³/day.

### EMBODIMENT

This embodiment takes a working face in a coal mine threatened by confined aquifers in Shanxi, China, as an example. After implementing floor grouting reinforcement, the floor water inflow significantly decreases, aiming to determine whether in-situ protection of the floor confined aquifer is achieved.

Step S1: by reviewing the mine geological and hydrogeological exploration reports and mine development plans, the average distance M between the mining coal seam floor and the aquifer, the average thickness M_{aqu} of the aquifer, the average permeability K_{aqu} of the aquifer, the working face length L_{face}, and the advance distance length L_{adv} are determined, as shown in Table 1.

TABLE 1
Aquifer-related parameters and working face parameters

| Average | | | | |
|---|---|---|---|---|
| distance | | | | |
| between | | | | |
| mining coal | | | | |
| seam floor | Average | Average | Working | Advance |
| and aquifer | thickness of | permeability of | face | distance |
| (m) | aquifer (m) | aquifer (D) | length (m) | length (m) |
| 100 | 60 | 1.0 × 10⁻⁹ | 100 | 600 |

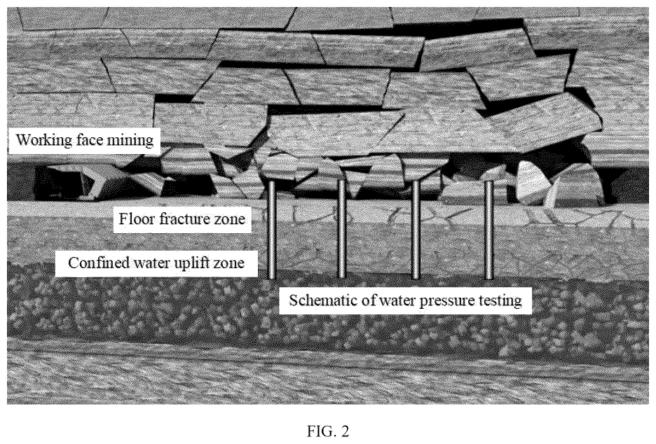

Step S2: within the mining range composed of the working face length=100 m and the advance distance length=600 m, a non-uniform grids of 10×5 drilling measurement points are arranged, as illustrated in FIG. 2. The measurement point spacings along the working face strike and dip directions are 66 m and 25 m respectively. At each drilling point, segmented water pressure tests are combined with directional coring to directly characterize fracture propagation below the coal seam floor, thereby determining the average depth M_{frac}=20 m of the mining coal seam floor fracture zone. The average thickness Mᵢ and average permeability Kᵢ of each rock layer below the fracture zone after mining are listed in Table 2.

TABLE 2
Floor rock layer conditions below the fracture zone

| | Average thickness | Average permeability | Cumulative |
|---|---|---|---|
| No. | of rock layer (m) | of rock layer (D) | thickness (m) |
| 1 | 10 | 1.50 × 10⁻⁹ | 10 |
| 2 | 20 | 2.00 × 10⁻⁹ | 30 |
| 3 | 20 | 3.00 × 10⁻⁹ | 50 |
| 4 | 20 | 1.00 × 10⁻⁹ | 70 |
| 5 | 10 | 5.00 × 10⁻⁹ | 80 |

The average thickness Mᵢ and average permeability Kᵢ of each rock layer below the fracture zone listed in Table 2 are substituted into the formula

$${K}_{e q} = ( M - {M}_{frac} ) \div {\sum }_{1}^{n} \frac{{M}_{i}}{{K}_{i}} ,$$

to calculate the equivalent permeability K_{eq}=1.76×10⁻⁹ D of the layered heterogeneous floor.

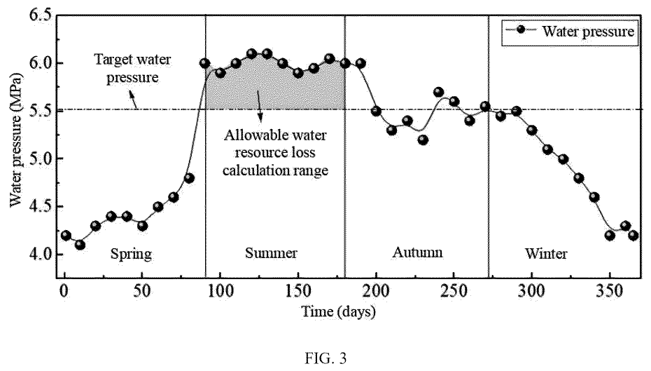

Step S3: based on long-term hydrogeological observation holes, the water pressure of the confined aquifer over one year is tested, as shown in FIG. 3. The average water pressures of the confined aquifer in spring and autumn are calculated as 4.45 MPa and 5.56 MPa respectively. The maximum value, 5.56 MPa, is taken as the target water pressure P_{target}. The water pressure P_{excess} of the confined aquifer exceeding the target water pressure P_{target} and the corresponding time t are statistically analyzed during summer and winter.

Step S4: the water pressure P_{excess} of the confined aquifer exceeding the target water pressure P_{target} and the time t are substituted into the formula

$${S}_{allow} = \frac{{K}_{a q u}}{μ} \times ∇ {\int }_{0}^{t} ( {P}_{excess} - {P}_{target} ) \times {L}_{face} \times {M}_{aqu} dt ,$$

to calculate the allowable water resource loss S_{allow}=293266.3 m³ during coal mining.

Step S5: the water pressure Pᵢ of the confined aquifer obtained in step S3 and the allowable water resource loss S_{allow} obtained in step S4, along with the working face water pressure P_{work} determined through on-site testing, are substituted into the formula

$${K}_{c r itical} = {S}_{allow} \times μ \div ( {L}_{adv} \times {L}_{face} \times {\int }_{0}^{{t}_{total}} ( ( {P}_{i} - {P}_{work} ) \div ( M - {M}_{frac} ) ) dt ) ,$$

to calculate the critical equivalent permeability coefficient K_{critical}=2.77×10⁻⁹ D of the water-resisting rock layers in the mining coal seam floor for achieving in-situ protection of floor confined water.

Step S6: the equivalent permeability K_{eq} of the layered heterogeneous floor obtained in step S2 is compared with the critical equivalent permeability coefficient K_{critical} of the water-resisting rock layers in the mining coal seam floor obtained in step S5. If K_{eq}≤K_{critical}, further judgment is required to determine whether in-situ protection of floor confined water may be achieved after coal seam mining.

The water pressure Pᵢ of the confined aquifer obtained in step S3 is substituted into the formula Q_{inflow}=K_{eq}÷μ×(Pᵢ−P_{work})÷(M−M_{frac})×L_{adv}×L_{face}, which may be simplified as

$${Q}_{inflow} = {K}_{eq} \div {K}_{critical} \times ( {P}_{i} - {P}_{work} ) \div {\int }_{0}^{{t}_{total}} ( {P}_{i} - {P}_{work} ) dt \times {S}_{allow} ,$$

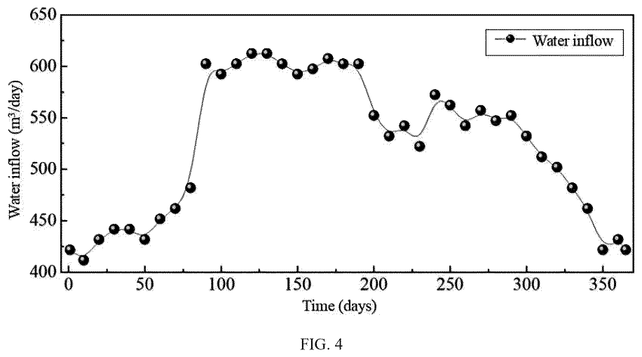

to calculate the unit-time water inflow Q_{inflow} over the total time range. As shown in FIG. 4, there is no continuous period of 5 days or more where Q_{inflow}≥1000 m³/day. Therefore, this embodiment may realize the in-situ protection of floor confined water.

In addition to the above embodiment, the present disclosure may be implemented in other forms. Any technical schemes formed by equivalent substitutions or transformations shall fall within the scope of protection claimed by the present disclosure.

What is claimed is:

1. A determination method for water-preserving mining with in-situ protection of floor confined water, comprising following steps:
S1, determining an average distance M between a mining coal seam floor and an aquifer, an average thickness M_{aqu} of the aquifer, an average permeability K_{aqu} of the aquifer, a working face length L_{face}, and an advance distance length L_{adv};
S2, detecting to obtain an average depth M_{frac} of a mining coal seam floor fracture zone, an average thickness Mᵢ of each rock layer below the fracture zone, an average permeability Kᵢ of each rock layer below the fracture zone, and an equivalent permeability K_{eq} of a layered heterogeneous floor;
S3, detecting and calculating a total time as tₜₒₜₐₗ, a water pressure Pᵢ in different time periods within a confined aquifer, and determining a target water pressure P_{target} of a target confined aquifer; comparing the detected water pressure Pᵢ of the confined aquifer with the target water pressure P_{target}, and obtaining a water pressure P_{excess} of the confined aquifer exceeding the target water pressure P_{target} and a time t, wherein the water pressure Pᵢ of the confined aquifer exceeds the target water pressure P_{target};
S4, substituting the target water pressure P_{target}, the water pressure P_{excess}, and the time t obtained in the step S3 into a formula
$${S}_{allow} = \frac{{K}_{a q u}}{μ} \times ∇ {\int }_{0}^{t} ( {P}_{excess} - {P}_{target} ) \times {L}_{face} \times {M}_{aqu} dt ,$$
to obtain an allowable water resource loss S_{allow} during coal mining;
wherein μ is a hydrodynamic viscosity coefficient in Pascal-second (Pa·s);
S5, substituting the water pressure Pᵢ of the confined aquifer obtained in the step S3 and the allowable water resource loss S_{allow} obtained in the step S4 into a formula
$${K}_{c r itical} = {S}_{allow} \times μ \div ( {L}_{adv} \times {L}_{face} \times {\int }_{0}^{{t}_{total}} ( ( {P}_{i} - {P}_{work} ) \div ( M - {M}_{frac} ) ) dt ) ,$$
to obtain a critical equivalent permeability coefficient K_{critical} of water-resisting rock layers in the mining coal seam floor;
wherein tₜₒₜₐₗ is a total detection time in days; K_{critical} is the critical equivalent permeability coefficient of the water-resisting rock layers in the mining coal seam floor in Darcy (D); and P_{work} is a working face water pressure in Megapascal (MPa); and
S6, determining feasibility of the water-preserving mining with the in-situ protection of the floor confined water;
S61, comparing the equivalent permeability K_{eq} of the layered heterogeneous floor obtained in the step S2 with the critical equivalent permeability coefficient K_{critical} of the water-resisting rock layers in the mining coal seam floor obtained in the step S5, wherein if K_{eq}>K_{critical}, the in-situ protection of the floor confined water may not be achieved after the coal mining; and if K_{eq}≤K_{critical}, the step S62 is executed; and
S62, substituting the equivalent permeability K_{eq} of the layered heterogeneous floor, the average depth M_{frac} of the mining coal seam floor fracture zone, the average distance M between the mining coal seam floor and the aquifer, the working face length L_{face}, the advance distance length L_{adv}, and the water pressure Pᵢ of the confined aquifer into a formula Q_{inflow}=K_{eq}÷μ×(Pᵢ−P_{work})÷(M−M_{frac})×L_{adv}×L_{face}, to obtain a unit-time water inflow Q_{inflow} over the total time; wherein if no continuous period exists with Q_{inflow}≥Q_{safe} lasting more than 5 days, the in-situ protection of the floor confined water may be achieved; and if there is the continuous period with Q_{inflow}≥Q_{safe} lasting more than 5 days, the in-situ protection of the floor confined water may not be achieved, wherein Q_{safe} is a safe water inflow for working face mining in cubic meters per day (m³/day).

2. The determination method for the water-preserving mining with the in-situ protection of the floor confined water according to claim 1, wherein the step S2 comprises following steps:
S21, arranging A×B drilling measurement points within a mining range composed of the working face length L_{face} and the advance distance length L_{adv}, and obtaining a plurality of depths of the mining coal seam floor fracture zone, thicknesses of rock layers below the mining coal seam floor fracture zone, and permeabilities;
S22, averaging the plurality of depths of the mining coal seam floor fracture zone, thicknesses of the rock layers, and permeabilities detected in the step S21, obtaining the average depth M_{frac} of the mining coal seam floor fracture zone, the average thickness Mᵢ of each rock layer below the mining coal seam floor fracture zone, and the average permeability Kᵢ of each rock layer below the mining coal seam floor fracture zone;
S23, substituting the average depth M_{frac} of the mining coal seam floor fracture zone, the average thickness Mᵢ of each rock layer below the mining coal seam floor fracture zone, and the average permeability Kᵢ of each rock layer below the mining coal seam floor fracture zone obtained in the step S22 into a formula
$${K}_{e q} = ( M - {M}_{frac} ) \div {\sum }_{1}^{n} \frac{{M}_{i}}{{K}_{i}} ,$$
to obtain the equivalent permeability K_{eq} of the layered heterogeneous floor; and wherein i=1, 2, 3, . . . , n, and n is the number of the rock layers below the mining coal seam floor fracture zone.

3. The determination method for the water-preserving mining with the in-situ protection of the floor confined water according to claim 2, wherein in the step S1, the average distance M between the mining coal seam floor and the aquifer, the average thickness M_{aqu} of the aquifer, the average permeability K_{aqu} of the aquifer, the working face length L_{face}, and the advance distance length L_{adv} are obtained through on-site drilling and by reviewing mine geological and hydrogeological exploration reports and mine development plans.

4. The determination method for the water-preserving mining with the in-situ protection of the floor confined water according to claim 2, wherein in the step S2, the depth of the mining coal seam floor fracture zone is primarily detected through on-site water pressure testing, supplemented by a parallel electrical method, the thickness of each rock layer below the mining coal seam floor fracture zone is obtained through on-site drilling, the plurality of thicknesses of the rock layers below the mining coal seam floor fracture zone are averaged to obtain the average thickness Mᵢ of each rock layer below the mining coal seam floor fracture zone, and the average permeability Kᵢ of each rock layer below the mining coal seam floor fracture zone is obtained through water pressure testing during drilling, followed by data averaging.

5. The determination method for the water-preserving mining with the in-situ protection of the floor confined water according to claim 2, wherein in the step S21, the A and the B are set to 10 and 5 respectively, and measurement point spacings along working face strike and dip directions are L_{adv}/9 and L_{face}/4 respectively.

6. The determination method for the water-preserving mining with the in-situ protection of the floor confined water according to claim 2, wherein in the step S3, the total detection time tₜₒₜₐₗ takes one year as one cycle, and the different time periods are divided into four quarters.

7. The determination method for the water-preserving mining with the in-situ protection of the floor confined water according to claim 6, wherein in the step S3, the target water pressure P_{target} is determined by calculating an average confined water pressure in spring and autumn and taking a maximum value as the target water pressure P_{target}.

8. The determination method for the water-preserving mining with the in-situ protection of the floor confined water according to claim 7, wherein in the step S4, the water pressure P_{excess} of the confined aquifer exceeding the target water pressure P_{target} and the time/are statistically analyzed during summer and winter states of the confined aquifer.

9. The determination method for the water-preserving mining with the in-situ protection of the floor confined water according to claim 6, wherein in the step S5, when the critical equivalent permeability coefficient K_{critical} of the water-resisting rock layers in the mining coal seam floor is calculated, the allowable water resource loss S_{allow} is averaged over each day of the year; and the working face water pressure P_{work} is obtained through on-site testing.

10. The determination method for the water-preserving mining with the in-situ protection of the floor confined water according to claim 2, wherein in the step S62, Q_{safe} is set to 1000 m³/day.
